(19) United States
(12) Patent Application Publication
(10) Pub. No.: US 2011/0107921 A1
(43) Pub. Date: May 12, 2011

(54) GRILLING DEVICE

(75) Inventors: Yixin ZHAN, Fujian Province (CN); Hwai-Hsiang Kuo, Tainan County (TW)

(73) Assignee: Tsann Kuen (Zhangzhou) Enterprise Co., Ltd., Fujian Province (CN)

(21) Appl. No.: 12/943,267

(22) Filed: Nov. 10, 2010

(30) Foreign Application Priority Data
Nov. 10, 2009 (CN) 200920314498.3

(51) Int. Cl. A47J 43/00; A47J 37/06

(52) U.S. Cl. 99/342; 99/377

(57) ABSTRACT

The present invention discloses a grilling device with automatic rotation function, comprising a base seat and a grilling pan unit rotatably disposed on the base seat; wherein said grilling pan has a pivot rotatably pivoted on the base seat. The grilling device as presented further comprises a control unit, a motor connected to the control unit and a transmission unit connected between the motor and the pivot, said motor and said transmission unit are installed on the base seat. Because the control unit, motor and transmission unit are cooperated with each other to form an automatic mechanism, so the rotation of the grilling pan unit can be controlled automatically, the operation is simpler and more convenient, the rotational angle and the rotational time of the grilling pan unit can be precisely controlled.

### FIELD OF THE INVENTION

The present invention relates to a grilling device, especially relates to a grilling device with automatic rotation function.

### BACKGROUND OF THE INVENTION

The existing grilling device comprises a base seat, a handle, and a grilling pan unit rotatably disposed on the base seat, said grilling pan is disposed with a pivot rotatably pivoted on the base seat, said handle is rotatably disposed on the base seat and fixed to the pivot coaxially, so the pivot can be driven to rotate by rotating the handle, thereby the grilling pan will be driven to rotate. However, because the rotation is by hand, so there are some shortages: firstly, the operation is not convenient since the user has to operate by hand; secondly, the grilling pan unit may not be evenly heated due to the manual rotation, so the taste of the food may be affected.

### SUMMARY OF THE INVENTION

The present invention provides an automatically rotational grilling device, which solves the shortages of the conventional grilling device which is not convenient for operation and the taste is not good.

The technical solution applied by the present invention is:

A grilling device, comprises a base seat and a grilling pan unit rotatably disposed on the base seat; wherein said grilling pan unit has a pivot rotatably pivoted on the base seat, and said grilling device further comprises a control unit, a motor connected to the control unit and a transmission unit connected between the motor and the pivot in a transmission manner, said motor and the transmission unit are installed on the base seat.

In a preferred embodiment, it further comprises two sensitive switches corresponding to said transmission unit, and said two sensitive switches are disposed on said base seat and connected to said control unit by signal.

In a preferred embodiment, said transmission unit comprises a first gear and a second gear, said first gear is connected to the power shaft of the motor, said second gear meshes with the first gear and fixed to the pivot coaxially.

In a preferred embodiment, said first gear comprises a circular body and a semicircle protruded from the outside of the semi-circle edge of the circular body, the outer edge of said semicircle has gear teeth, the front and rear ends of said semicircle are respectively corresponding to the two sensitive switches.

In a preferred embodiment, said circular body is fixed to the power shaft of the motor coaxially.

In a preferred embodiment, it further comprises a motor holder which is fixed to the base seat, and said motor is disposed in the motor holder.

In a preferred embodiment, said control unit comprises a substrate connected to the motor and connected to the sensitive switch by signal, and a control panel connected to the substrate by signal.

In a preferred embodiment, said control unit is disposed on the base seat.

In a preferred embodiment, it further comprises a handle and a switcher connected to the pivot in a transmission manner, said handle is rotatably connected to the base seat, said switcher connects the handle and the transmission unit.

Referred from the description of the structure of the present invention, the present invention has such advantages compared to the background technique: because there are a control unit, a motor and a transmission unit, so they form an automatic mechanism, which can control the rotation of the grilling pan unit automatically, the operation is simpler and more convenient, the rotational angle and the rotational time of the grilling pan unit can be controlled precisely. Because there further has sensitive switches, so it will realize precise control. Because the first gear further has a semicircle, the gear teeth are disposed on the semicircle, so not only the rotational angle of the pivot can reach 180 degrees, but also it will be convenient for cooperating with the sensitive switches. Because the control panel is connected to the substrate, so the grilling device can rotate automatically with the control panel. Because there further has a switcher and a handle, so the user can freely choose the manual control manner or the automatic control manner.

### BRIEF DESCRIPTION OF THE DRAWINGS

FIG. 1 is the first perspective view of the grilling device of the present invention.

FIG. 2 is the second perspective view of the grilling device of the present invention.

FIG. 3 is the first view of the grilling device of the present invention when it is in the working state.

FIG. 4 is the second view of the grilling device of the present invention when it is in the working state.

FIG. 5 is the exploded view of the grilling device of the present invention.

### DETAILED DESCRIPTION OF THE EMBODIMENTS

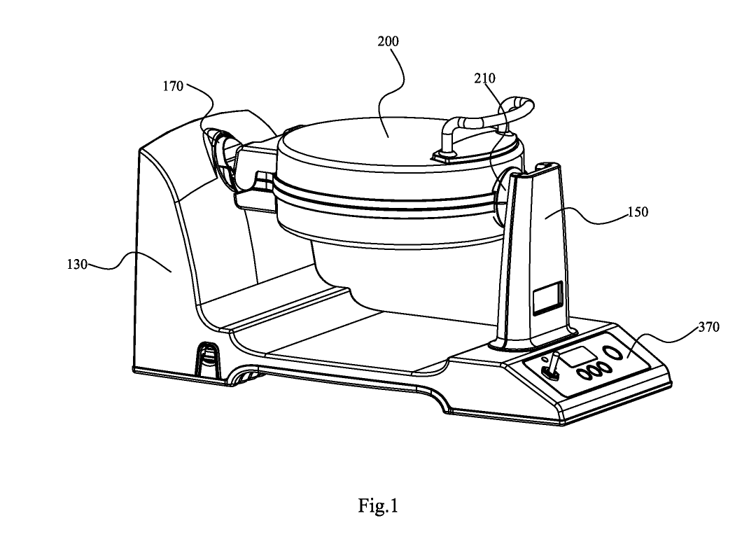

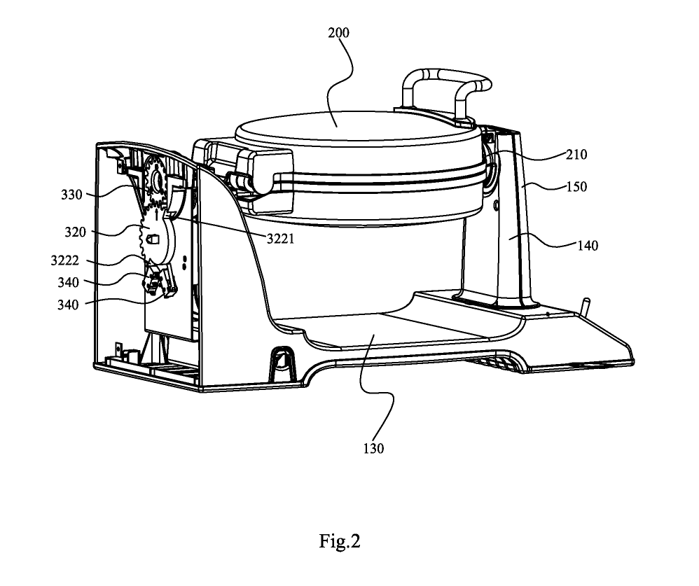

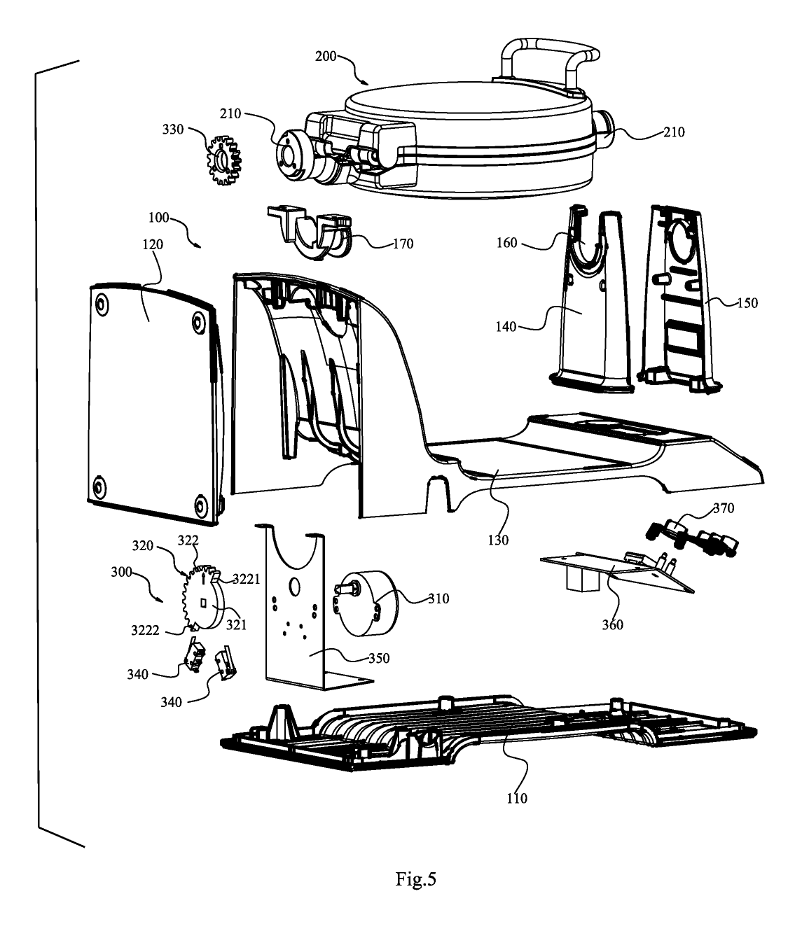

Please refer to FIG. 1, FIG. 2 and FIG. 5, the grilling device with automatic rotation function comprises a base seat 100, a grilling pan unit 200 rotatably disposed on the base seat 100 and an automatic mechanism 300.

Said base seat 100 comprises a base cover 110, a rear cover 120, a bottom 130, a front supporting shelf 140 and a rear supporting shelf 150, a revolving shaft hole 160 is disposed on said front supporting shelf 140 and the rear supporting shelf 150, a revolving shaft seat 170 is disposed on a side of said bottom 130.

Said grilling pan unit 200, the front and rear ends of which are respectively protruded to form a pivot 210, said two pivots 210 are pivoted on the revolving shaft seat 170 and the revolving shaft hole 160, so the grilling pan unit 200 can rotatably connected to the base seat 100.

Said automatic mechanism 300 comprises a control unit, a synchronous motor 310, a first gear 320, a second gear 330, two sensitive switches 340 and a motor holder 350. Said motor holder 350 is fixed to the base seat 100, said synchronous motor 310 is disposed on the motor holder 350. Said first gear 320 comprises a circular body 321 and a semicircle 322 protruded outside of the semi-circle edge of the circular body, the outer edge of said semicircle 322 has gear teeth, and the front end 3221 and rear end 3222 of said semicircle. Said first gear 320 is disposed on the base seat 100, further, it is fixed to the power shaft of motor 310 coaxially. Said second gear 330 is disposed on the base seat 100, further, it meshes with the first gear 320 and fixed to the pivot 210 coaxially. Said two sensitive switches 340 are disposed on the base seat 100 and respectively corresponding to the front end 3221 and the rear end 3222 of the first gear 320. Said control unit comprises a substrate 360 and a control panel 370, they are disposed on the bottom 130 of the base seat 100, moreover, said control panel 370 is exposed outside of the bottom 130 for the user to control. Said substrate 360 is connected to the control panel 370 by signal, connected to the sensitive switches 340 by signal and controls the synchronous motor 310.

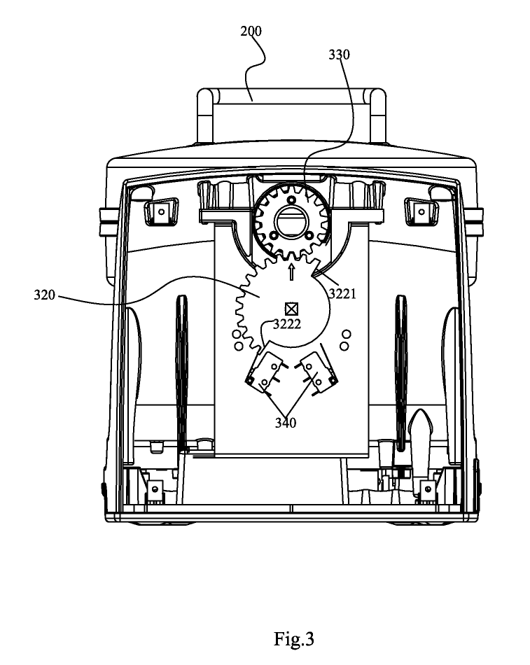

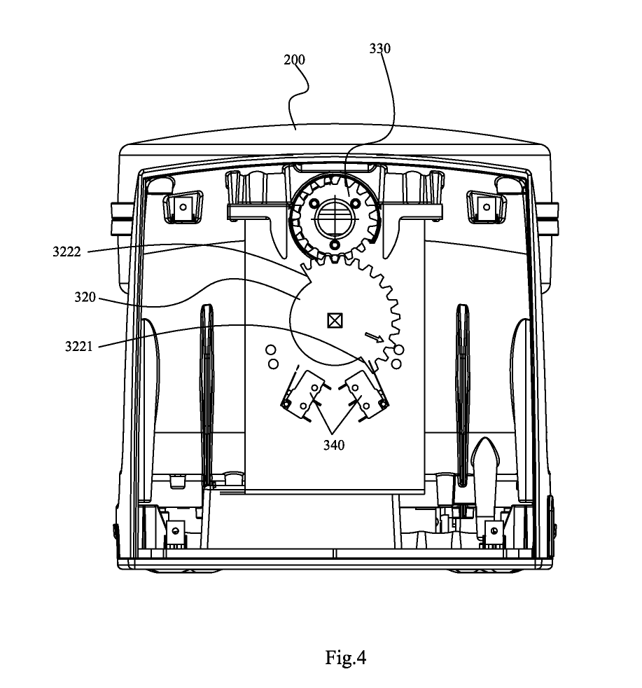

In the present embodiment, said control panel 370 can be designed with keys respectively representing the “reset, color and start” functions. In the present invention, the substrate is applied to control the power-on and power-off of the rotation of the synchronous motor, the grilling pan unit is driven to rotate with 180 degrees with the transmission of the first gear and the second gear. The working procedure of the present embodiment is: step 1, after the device is power-on and preheated, adjusting the time with “color” key, then pressing the “start” key, at this time the motor is started, so the motor will drive the grilling pan unit 200 rotate through the transmission unit (the first gear 320 and the second gear 330), when the working state of the second gear 330 is shifted from state 1 of FIG. 3 to the state 2 of FIG. 4, touching the sensitive switch 340 to stop rotating, at this time the grilling pan unit 200 just rotate with 180 degrees; step 2, after pressing the “start” key, the time showed on the liquid crystal display begins to count down, when the time is counted out, the motor 310 is started to drive the grilling pan unit 200 rotate with a reverse direction through the transmission unit, the working state of the second gear 330 is shifted from state 2 of FIG. 4 to state 1 of FIG. 3, touching the sensitive switch 340 to stop rotating, at this time the grilling pan unit 200 will back to its original position (state 1). step 3, once the grilling pan unit 200 is started to rotate, it needs to press “reset” key, only that the grilling pan unit can back to its original position (state 1). After the “reset” key is pressed, the user can re-choose time by pressing the “color” key again, after the time is determined, the automatically rotational function can be re-started by pressing the “start” key.

In another preferred embodiment, its difference between the first preferred embodiment is: it further comprises a switcher connected to the pivot in a transmission manner, and a handle rotatably connected to the base seat, said switcher connects the handle and the transmission unit.

Although the present invention has been described with reference to the preferred embodiments thereof for carrying out the invention, it is apparent to those skilled in the art that a variety of modifications and changes may be made without departing from the scope of the present invention which is intended to be defined by the appended claims.

What is claimed is:

1. A grilling device, comprises a base seat and a grilling pan unit rotatably disposed on the base seat; wherein said grilling pan unit has a pivot rotatably pivoted on the base seat, and said grilling device further comprises a control unit, a motor connected to the control unit and a transmission unit connected between the motor and the pivot in a transmission manner, said motor and the transmission unit are installed on the base seat.

2. The grilling device according to claim 1, wherein it further comprises two sensitive switches corresponding to said transmission unit, and said two sensitive switches are disposed on said base seat and connected to said control unit by signal.

3. The grilling device according to claim 2, wherein said transmission unit comprises a first gear and a second gear, said first gear is connected to the power shaft of the motor, said second gear meshes with the first gear and fixed to the pivot coaxially.

4. The grilling device according to claim 3, wherein said first gear comprises a circular body and a semicircle protruded from the outside of the semi-circle edge of the circular body, the outer edge of said semicircle has gear teeth, the front and rear ends of said semicircle are respectively corresponding to the two sensitive switches.

5. The grilling device according to claim 4, wherein said circular body is fixed to the power shaft of the motor coaxially.

6. The grilling device according to claim 1, wherein it further comprises a motor holder which is fixed to the base seat, and said motor is disposed in the motor holder.

7. The grilling device according to claim 1, wherein said control unit comprises a substrate connected to the motor and connected to the sensitive switch by signal, and a control panel connected to the substrate by signal.

8. The grilling device according to claim 1, wherein said control unit is disposed on the base seat.

9. The grilling device according to claim 1, wherein it further comprises a handle and a switcher connected to the pivot in a transmission manner, said handle is rotatably connected to the base seat, said switcher connects the handle and the transmission unit.

10. The grilling device according to claim 2, wherein it further comprises a motor holder which is fixed to the base seat, and said motor is disposed in the motor holder.

11. The grilling device according to claim 3, wherein it further comprises a motor holder which is fixed to the base seat, and said motor is disposed in the motor holder.

12. The grilling device according to claim 4, wherein it further comprises a motor holder which is fixed to the base seat, and said motor is disposed in the motor holder.

13. The grilling device according to claim 5, wherein it further comprises a motor holder which is fixed to the base seat, and said motor is disposed in the motor holder.

14. The grilling device according to claim 2, wherein said control unit comprises a substrate connected to the motor and connected to the sensitive switch by signal, and a control panel connected to the substrate by signal.

15. The grilling device according to claim 3, wherein said control unit comprises a substrate connected to the motor and connected to the sensitive switch by signal, and a control panel connected to the substrate by signal.

16. The grilling device according to claim 4, wherein said control unit comprises a substrate connected to the motor and connected to the sensitive switch by signal, and a control panel connected to the substrate by signal.

17. The grilling device according to claim 5, wherein said control unit comprises a substrate connected to the motor and connected to the sensitive switch by signal, and a control panel connected to the substrate by signal.

18. The grilling device according to claim 2, wherein said control unit is disposed on the base seat.

19. The grilling device according to claim 3, wherein said control unit is disposed on the base seat.

20. The grilling device according to claim 4, wherein said control unit is disposed on the base seat.

21. The grilling device according to claim 5, wherein said control unit is disposed on the base seat.

22. The grilling device according to claim 2, wherein it further comprises a handle and a switcher connected to the pivot in a transmission manner, said handle is rotatably connected to the base seat, said switcher connects the handle and the transmission unit.

23. The grilling device according to claim 3, wherein it further comprises a handle and a switcher connected to the pivot in a transmission manner, said handle is rotatably connected to the base seat, said switcher connects the handle and the transmission unit.

24. The grilling device according to claim 4, wherein it further comprises a handle and a switcher connected to the pivot in a transmission manner, said handle is rotatably connected to the base seat, said switcher connects the handle and the transmission unit.

25. The grilling device according to claim 5, wherein it further comprises a handle and a switcher connected to the pivot in a transmission manner, said handle is rotatably connected to the base seat, said switcher connects the handle and the transmission unit.
